(19) United States
(12) Patent Application Publication
(10) Pub. No.: US 2026/0132275 A1
(43) Pub. Date: May 14, 2026

(54) RUBBER COMPOSITION BASED ON PYROLYSIS CARBON BLACK AND EPOXY RESIN

(71) Applicant: COMPAGNIE GENERALE DES ETABLISSEMENTS MICHELIN, Clermont-Ferrand (FR)

(72) Inventors: ALINE RIOU, Clermont-Ferrand (FR); FABIEN BONNETTE, Clermont-Ferrand (FR); MARINE BONNEVIDE, Clermont-Ferrand (FR)

(21) Appl. No.: 19/118,112

(22) PCT Filed: Sep. 28, 2023
(86) PCT No.: PCT/EP2023/076925

§ 371 Date: Apr. 3, 2025

(30) Foreign Application Priority Data
Oct. 4, 2022 (FR) FR2210125

(51) Int. Cl. C08L 7/00; B60C 1/00; C08G 59/32; C08G 59/40; C08K 3/04; C08K 3/06; C08K 5/47

(52) U.S. Cl. CPC C08L 7/00; B60C 1/00; C08G 59/32; C08G 59/4021; C08K 3/04; C08K 3/06; C08K 5/47; C08L 2312/02

(57) ABSTRACT

A rubber composition is based on at least a diene elastomer, a reinforcing filler comprising pyrolysis carbon black, a crosslinking system, between 1 and 30 phr of an epoxy resin and between 0.5 and 15 phr of a hardener.

### TECHNICAL FIELD OF THE INVENTION

The present invention relates to rubber compositions intended in particular for the manufacture of tyres or of semi-finished products for tyres. Another subject of the present invention is a finished or semi-finished rubber article comprising a rubber composition according to the invention, and also a pneumatic or non-pneumatic tyre comprising at least one rubber composition according to the invention.

### PRIOR ART

It is known to use, in some parts of pneumatic tyres, rubber compositions exhibiting a high stiffness during small strains of the pneumatic tyre, as presented in application WO 02/10269. Resistance to small strains is one of the properties which a pneumatic tyre has to exhibit in order to respond to the stresses to which it is subjected.

This stiffening can be obtained by increasing the content of reinforcing filler or by incorporating certain reinforcing resins in the constituent rubber compositions of the parts of the pneumatic tyre.

The reinforcing resins conventionally used to increase the stiffness of the rubber compositions are reinforcing resins based on a methylene acceptor/donor system. The terms “methylene acceptor” and “methylene donor” are well known to a person skilled in the art and are widely used to denote compounds capable of reacting together to generate, by condensation, a reinforcing resin according to a three-dimensional network which will become superimposed and interpenetrated with the reinforcing filler/elastomer network, on the one hand, and with the elastomer/sulfur network, on the other hand (if the crosslinking agent is sulfur). Conventionally, the methylene acceptor is a phenolic resin. Phenolic novolac resins have already been used in rubber compositions, in particular intended for pneumatic tyres or treads of pneumatic tyres, for applications as varied as grip or reinforcement: reference will be made, for example, to patent EP 0 649 446 B1.

The methylene acceptor described above is combined with a hardener, capable of crosslinking or hardening it, also commonly known as “methylene donor” or simply “hardener”. Crosslinking of the resin is then brought about, during the curing of the rubber matrix, by formation of methylene bridges between the carbons in the ortho and para positions of the phenolic nuclei of the resin and the methylene donor, thus creating a three-dimensional resin network.

Application WO 2011/045342 describes rubber compositions comprising an epoxy resin pair with an amine-comprising hardener. These compositions, in addition to the advantage of being freed from the formation of formaldehyde, exhibit, after crosslinking, greater stiffnesses than conventional compositions while retaining an acceptable rolling resistance. Application WO 2018/002538 describes rubber compositions comprising an epoxy resin and an amine-comprising hardener comprising at least two primary amine functions located on at least one six-membered aromatic ring which are targeted at improving the compromise between processability, in particular the scorch time, and stiffness in comparison with the known rubber compositions.

In order to minimize the environmental impact of the manufacture of rubber articles, in particular pneumatic tyres, new reinforcing fillers from the recycling of rubber articles have been developed. These “pyrolysis” carbon blacks have reinforcing properties. However, because of their nature, different from carbon blacks produced directly from fossil resources, known as ASTM blacks, the interactions between pyrolysis carbon blacks and the other components of rubber compositions and their impact on the performance of rubber articles are still poorly defined.

It is always desirable to further improve the properties of the rubber compositions, and in particular the compromise between stiffness and hysteresis losses, without degrading the properties in the uncured state of these compositions, while minimizing the environmental impact of these compositions.

Unexpectedly, the applicant discovered during its research that the combination of an epoxy resin and a pyrolysis carbon black makes it possible to improve the stiffness at low strains and the hysteresis losses of a rubber composition while not degrading the uncured properties, in particular the viscosity of the compositions, while at the same time minimizing the environmental impact of such compositions.

### DETAILED DESCRIPTION OF THE INVENTION

Thus, a subject of the invention is a rubber composition based on at least:
a diene elastomer;
a reinforcing filler comprising pyrolysis carbon black;
a crosslinking system;
between 1 and 30 phr of an epoxy resin;
between 0.5 and 15 phr of a hardener.

### Definitions

The compounds comprising carbon which are mentioned in the description can be of fossil origin or be biobased. In the latter case, they may be, partially or completely, derived from biomass or obtained from renewable raw materials derived from biomass. This particularly concerns polymers, plasticizers, fillers, etc.

### Diene Elastomers

The rubber composition according to the invention comprises at least a diene elastomer. It should be remembered that the term “elastomer of the diene type” should be understood as meaning an elastomer which results at least in part (i.e. a homopolymer or a copolymer) from diene monomers (monomers bearing two conjugated or non-conjugated carbon-carbon double bonds).

These diene elastomers can be classified into two categories: “essentially unsaturated” or “essentially saturated”. The term “essentially unsaturated” is understood to mean generally a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content, always less than 15% (mol %), of units of diene origin). The diene elastomers included in the rubber composition according to the invention are preferentially essentially unsaturated.

The term “diene elastomer capable of being used in the rubber compositions in accordance with the invention” is understood in particular to mean:
a) any homopolymer of a conjugated or non-conjugated diene monomer having from 4 to 18 carbon atoms;
b) any copolymer of a conjugated or non-conjugated diene having from 4 to 18 carbon atoms and of at least one other monomer.

The other monomer can be ethylene, an olefin or a conjugated or non-conjugated diene.

Suitable conjugated dienes are conjugated dienes having from 4 to 12 carbon atoms, in particular 1,3-dienes, such as especially 1,3-butadiene and isoprene.

Suitable olefins are vinylaromatic compounds having from 8 to 20 carbon atoms and aliphatic α-monoolefins having from 3 to 12 carbon atoms.

Suitable as vinylaromatic compounds are, for example, styrene, ortho-, meta- or para-methylstyrene, the “vinyltoluene” commercial mixture or para-(tert-butyl)styrene.

Suitable aliphatic α-monoolefins are especially acyclic aliphatic α-monoolefins having from 3 to 18 carbon atoms.

The diene elastomer is preferably a diene elastomer of the highly unsaturated type, in particular a diene elastomer selected from the group consisting of natural rubber (NR), synthetic polyisoprenes (IRs), polybutadienes (BRs), butadiene copolymers, isoprene copolymers and the mixtures of these elastomers. Such copolymers are more preferentially selected from the group consisting of butadiene/styrene copolymers (SBRs), isoprene/butadiene copolymers (BIRs), isoprene/styrene copolymers (SIRs), isoprene/butadiene/styrene copolymers (SBIRs), ethylene/butadiene copolymers (EBRs) and the mixtures of such copolymers.

The above diene elastomers can, for example, be block, random, sequential or microsequential elastomers and be prepared in dispersion or in solution; they can be coupled and/or star-branched or also functionalized with a coupling and/or star-branching or functionalization agent, for example epoxidized.

Preferably, the rubber composition according to the invention comprises at least 50 phr, preferentially at least 70 phr, preferably at least 90 phr of at least one isoprene elastomer. In a highly preferred embodiment, the elastomeric composition of the composite according to the invention comprises 100 phr of at least one isoprene elastomer.

The term “isoprene elastomer” is understood to mean an isoprene homopolymer or copolymer, in other words a diene elastomer selected from the group consisting of natural rubber (NR), which may be plasticized or peptized, synthetic polyisoprenes (IRs), the various isoprene copolymers, in particular isoprene/styrene (SIRs), isoprene/butadiene (BIRs) or isoprene/butadiene/styrene (SBIRs) copolymers, and the mixtures of these elastomers.

Preferably, the isoprene elastomer is selected from the group consisting of synthetic polyisoprenes, natural rubber, isoprene copolymers and mixtures thereof, preferably from the group consisting of natural rubber, polyisoprenes comprising a content by weight of cis-1,4-bonds of at least 90%, more preferentially of at least 98%, relative to the weight of isoprene elastomer, and mixtures thereof. Very preferably, the isoprene elastomer is natural rubber.

In the rubber compositions according to the invention, the elastomer represents a continuous phase within which the other constituents are dispersed.

### Epoxy Resin

The rubber composition according to the invention comprises between 1 and 30 phr of an epoxy resin.

The epoxy resins which can be used in the present invention include all the polyepoxide compounds. They can concern, for example, aromatic epoxy, alicyclic epoxy and aliphatic epoxy resins. For example, the aromatic epoxy resin can be an amine-aromatic epoxy resin. These resins are preferably epoxy novolac resins, that is to say epoxy resins obtained by acid catalysis, in contrast to resol resins, which are obtained by basic catalysis.

In particular among aromatic epoxy compounds, preference is given to epoxy resins selected from the group consisting of resins of the type 2,2-bis[4-(glycidyloxy)phenyl]propane, poly[(o-cresyl glycidyl ether)-co-formaldehyde], poly[(o-phenyl glycidyl ether)-co-formaldehyde], poly[(phenyl glycidyl ether)-co-(hydroxybenzaldehyde glycidyl ether)], tri(glycidoxyphenyl)methane, tetra(glycidoxyphenyl)ethane, and the mixtures of these resins.

The term “epoxy resin of the type” is understood to mean resins based on units of the constituent, that is to say comprising this constituent, or oligomers of this constituent.

The epoxy resin is a curing resin. The term “curing resin” is understood to mean a resin which, when incorporated into a rubber composition with a curing agent, makes it possible to increase the stiffness of the rubber composition after crosslinking. As it happens, the increase in stiffness of a rubber composition generally goes hand in hand with an increase in hysteresis losses.

Preferably again, the epoxy resin is selected from the group consisting of resins of the type poly[(o-cresyl glycidyl ether)-co-formaldehyde], poly[(o-phenyl glycidyl ether)-co-formaldehyde], tri(glycidoxyphenyl)methane, tetra(glycidoxyphenyl)ethane, and the mixtures of these resins.

Very preferentially, the epoxy resin used in the context of the invention is selected from the epoxy resins having the following generic formulae (I) and (II) and derivatives thereof, that is to say the oligomers of the compounds of generic formulae (I) and (II):

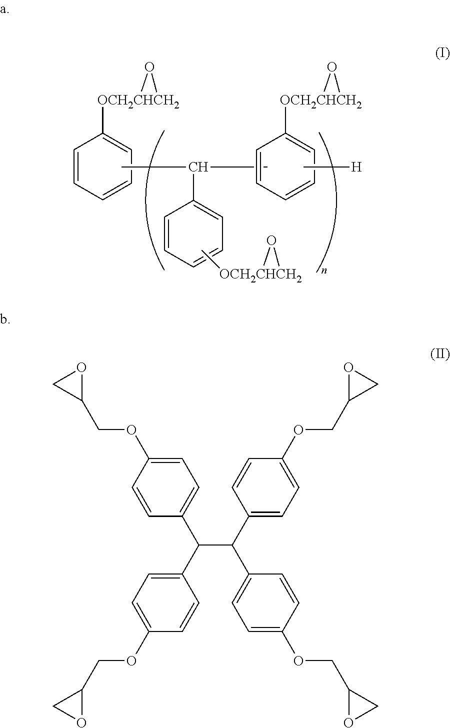

n being an integer expressing the degree of polymerization, n ranging from 1 to 15, preferentially from 1 to 10, more preferentially from 1 to 5 and very preferentially from 1 to 3.

Examples of commercially available epoxy resins which can be used in the context of the present invention that can be mentioned are, for example, the DEN 439 epoxy resin from Uniqema, the tris(4-hydroxyphenyl)methane triglycidyl ether epoxy resin from Sigma-Aldrich, the Araldite ECN 1299 epoxy cresol novolac resin from Huntsman or the Araldite EPN 1138 epoxy phenol novolac resin from Huntsman, the EPPN-502H, EPPN-501H and EPPN-501HY resins from Nippon Kayaku, or the EPON 1031 resin from Hexion.

Preferably, the rubber composition according to the invention does not comprise curing resins other than an epoxy resin, and in particular does not comprise resins of phenol/formaldehyde type.

The amount of epoxy resin is between 1 and 30 phr. In view of the amine-comprising hardener used in the context of the present invention, below the minimum content of epoxy resin indicated, the targeted technical effect is insufficient whereas, above the maximum indicated, risks arise of an excessively great increase in the stiffness and of excessive damage to the hysteresis and to the Mooney plasticity. More preferably, the content of epoxy resin in the rubber composition according to the invention is between 10 and 28 phr. The contents of epoxy resin of the present invention make it possible to ensure sufficient stiffness of the rubber composition while allowing the latter to retain an elastic-type behaviour once crosslinked.

### Hardener

The rubber composition according to the invention comprises from 0.5 to 15 phr of a hardener. Any hardener capable of crosslinking the epoxy resin used in the rubber compositions according to the invention may be suitable as a hardener. In particular, the hardener may be selected from aromatic diamines, aliphatic diamines, anhydrides such as, for example, benzoic anhydride and maleic anhydride, and ureas.

Urea hardeners are compounds of general formula (R₁,R₂)N—CO—N(R₃,R₄) or (R₁,R₂)N—CO—(NR₃)—R₇—(NR₄)—CO—N(R₅,R₆) in which each R₁ to R₆ radical is independently selected from the group consisting of.
a hydrogen atom,
an alkyl radical having from 1 to 20 carbon atoms,
a cycloalkyl radical having from 5 to 24 carbon atoms,
an aryl radical having from 6 to 30 carbon atoms and
an aralkyl radical having from 7 to 25 carbon atoms.

In the general formula (R₁,R₂)N—CO—N(R₃,R₄), it is understood that the group CO represents a carbon atom bonded via a double bond to an oxygen atom, and that the group (R₁,R₂)N (respectively N(R₃,R₄)) represents a nitrogen atom bonded to a group R₁ and to a group R₂ via a covalent bond. Such a molecule is shown below.

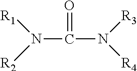

In the general formula (R₁,R₂)N—CO—(NR₃)—R₇—(NR₄)—CO—N(R₅,R₆), it is understood that the CO group represents a carbon atom bonded via a double bond to an oxygen atom, that the (R₁,R₂)N (respectively N(R₅,R₆)) group represents a nitrogen atom bonded to an R₁ group and to an R₂ group via a covalent bond, that the (NR₃) (respectively (NR₄)) group represents a nitrogen atom bonded to an R₃ group via a covalent bond and that the R₇ group represents a divalent group bonded, on the one hand, to the nitrogen atom bearing the R₃ group and, on the other hand, to the nitrogen atom bearing the R₄ group.

Preferably, the hardener is selected from aromatic diamines and ureas. These families of hardeners in fact exhibit a speed of crosslinking during curing/stiffness of the crosslinked product balance which is particularly advantageous for the rubber compositions according to the invention.

Very preferentially, according to the invention, the aromatic diamine-comprising hardener is selected from the group consisting of the compounds below and the mixtures of these compounds:

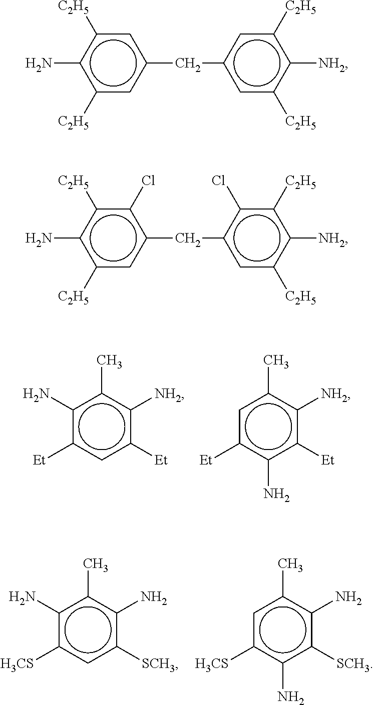

Mention may be made, as examples of commercially available amine-comprising hardeners which can be used in the context of the present invention, for example, of Ethacure 100 or Ethacure 300 from Albemarle or Lonzacure DETDA, Lonzacure MDEA or Lonzacure MCDEA from Lonza.

Preferably, the ureas do not comprise an aromatic ring.

Preferably, each radical R₁, R₂, R₃ and R₄ is a hydrogen atom. The compound of formula H₂N—CO—NH₂ is commonly referred to as “urea” or “carbamide”.

Preferably, in the compound of general formula (R₁,R₂)N—CO—(NR₃)—R₇—(NR₄)—CO—N(R₅,R₆), the radicals R₁, R₂, R₅ and R₆ are methyl radicals, R₃ and R₄ are a hydrogen atom and R₇ is a divalent methylphenyl radical. An example of such a di-urea compound is the compound Amicure UR2T from Evonik, of formula 1,1′-(4-methyl-m-phenylene)bis(3,3-dimethylurea).

Very preferentially, according to the invention, the ureas are selected from carbamide, N,N′-dimethylurea, ethyleneurea, N-phenylurea 1,3-diphenylurea and 1,1′-(4-methyl-m-phenylene) bis(3,3-dimethylurea) compounds, preferably selected from urea, N,N′-dimethylurea, N-phenylurea, 1,3-diphenylurea and 1,1′-(4-methyl-m-phenylene) bis(3,3-dimethylurea) compounds and very preferably selected from carbamide, N,N′-dimethylurea and 1,1′-(4-methyl-m-phenylene) bis(3,3-dimethylurea) compounds and very preferentially is carbamide, also called urea, of formula H₂N—CO—NH₂.

The amount of hardener in the rubber composition is within a range extending from 0.5 to 15 phr. Below the minimum indicated, the targeted technical effect has proved to be insufficient whereas, above the maximum indicated, risks arise of the processing in the uncured state of the rubber compositions being disadvantaged. Preferentially, the content of hardener is within a range extending from 0.5 to 10 phr, preferably within a range extending from 0.5 to 8 phr.

### Pyrolysis Carbon Black

The rubber composition according to the invention comprises a reinforcing filler comprising pyrolysis carbon black, preferentially comprising predominantly pyrolysis carbon black. The term “predominantly” is understood to mean that the pyrolysis black represents at least 50% by weight of the total weight of reinforcing filler. Preferably, the pyrolysis black represents at least 70% by weight of the total weight of reinforcing filler, preferentially at least 80% by weight of the total weight of reinforcing filler, preferably at least 90% by weight of the total weight of reinforcing filler. Very preferably, the reinforcing filler consists of pyrolysis black.

For the purposes of the present invention, the term “pyrolysis carbon black” is understood to mean a carbon black resulting from a process of pyrolysis of a carbon-based polymeric material comprising at least one polymer and a carbon black, hereinafter the material to be pyrolysed, this material possibly resulting from recycling. The term “recycling” is understood to mean a process which makes it possible to treat a product that has possibly been used, in order to reintroduce some of these materials into the production of new objects. The term “carbon-based polymeric material” is understood to mean a material comprising at least one polymer based on hydrogen and carbon. The physical state under which this material to be pyrolysed is provided is not important, whether it is in the form of a powder, granule, strip or any other appropriately densified form, in the crosslinked or non-crosslinked state.

Preferentially, the material to be pyrolysed can be recovered from manufactured articles or from products generated during their manufacture/production (such as by-products or scrap); it being possible for these manufactured articles to be selected from the group consisting of pneumatic tyres, non-pneumatic tyres, industrial conveyor belts, transmission belts, rubber gaskets, rubber hoses, footwear soles and windscreen wipers. Even more preferentially, the pyrolysis carbon black that may be used in the context of the present invention is a carbon black obtained from a pyrolysis process of which the material to be pyrolysed is derived from manufactured articles selected from the group consisting of pneumatic tyres and non-pneumatic tyres.

Pyrolysis in the context of the present invention means any type of thermal decomposition in the absence of oxygen, the raw material of which is the material to be pyrolysed as defined above. Pyrolysis carbon blacks thus differ from “industrial” and/or “ASTM-grade” carbon blacks in that the carbon-based raw material used for the pyrolysis is a material comprising at least a carbon-based polymer and a carbon black and not materials derived from petroleum cuts or derived from coal or else from oils of natural origin.

Pyrolysis carbon blacks are sold, for example, by BlackBear under the reference “BBCT30” or by Scandinavian Enviro Systems under the reference “P550”.

The pyrolysis carbon blacks that may be used in the context of the present invention differ from known carbon blacks such as industrial carbon blacks, in particular “furnace” carbon blacks, notably by a higher ash content.

Preferentially, the pyrolysis carbon black that can be used in the context of the present invention has an ash content within a range extending from 5% to 30% by weight, more preferentially ranging from 8% to 25% by weight, more preferentially still from 10% to 22% by weight, relative to the total weight of the pyrolysis carbon black.

Preferentially, the pyrolysis carbon black which can be used in the context of the present invention also has a sulfur content of greater than 2% by weight, preferably ranging from 2.5% to 5% by weight, relative to the total weight of the pyrolysis carbon black.

Preferentially, the pyrolysis carbon black which can be used in the context of the present invention also has a zinc content of greater than or equal to 2% by weight, preferably ranging from 2.5% to 8% by weight, relative to the total weight of the pyrolysis carbon black.

Preferentially, the pyrolysis carbon black which can be used in the context of the present invention exhibits an STSA specific surface, measured according to ASTM Standard D 6556-2021, within a range extending from 20 to 200 m²/g, more preferentially extending from 30 to 90 m²/g.

Preferentially, the pyrolysis carbon black which can be used in the context of the present invention exhibits a void volume, measured according to ASTM Standard D7854 (2018) and at a pressure of 50 MPa, within a range extending from 30 to 60 ml/100 g, more preferentially extending from 35 to 55 ml/100 g.

The ash content is determined by calcination in platinum capsules in a muffle furnace at 825° C. according to the following protocol. A capsule is identified beforehand before each series of measurements and is tared to within 0.1 mg and the weight is denoted P0. 5 g of pyrolysis carbon black sample are introduced into the capsule. The capsule is weighed precisely to within 0.1 mg; this mass is denoted P1. The capsule and its contents are pre-calcined using a Bunsen burner until smoke appears and the product is ignited. Once combustion of the product is complete, the capsule and its contents are introduced into a muffle furnace heated to 825° C. for 1 h. After 1 h, the capsule is removed from the furnace and immediately introduced into a desiccator at ambient temperature. When the capsule and the ash have returned to ambient temperature, the capsule is again weighed in order to obtain the weight P2. Finally, it is possible to obtain the ash content (% ash) using the formula below:

$$\% ash = \frac{P 2 - P 0}{P 1 - P 0} \times 100$$

The content of zinc in the pyrolysis black is measured after calcination of the sample, followed by take-up of the ashes in an acidic medium and assay by ICP-AES (inductively coupled plasma atomic emission spectroscopy). The ash contents are obtained by carrying out the protocol already described above. 100 mg of ash (test sample) are taken and introduced into a PFA (perfluoroalkoxy) tube for a HotBlock hotplate. 8 ml of 37% concentrated hydrochloric acid, 3 ml of 65% concentrated nitric acid and 0.5 ml of 40% hydrofluoric acid are subsequently added. The tube is closed with a stopper and is heated to 130° C. for 2 h. After cooling, the contents are then transferred using ultrapure water into a 100 ml PTFE (polytetrafluoroethylene) volumetric flask already containing 2 g of boric acid (to neutralize the hydrofluoric acid). The solution is made up to the mark with ultrapure water. The solution obtained is diluted by 100, by withdrawing 1 ml into a 100 ml PFTE flask containing beforehand 8 ml of 37% concentrated hydrochloric acid, 3 ml of 65% concentrated nitric acid, 0.5 ml of 40% hydrofluoric acid and 2 g of boric acid. This diluted solution is then filtered through a 0.45 m GHP syringe filter before being analysed by ICP-AES. Prior to the analysis of the diluted solution, at least 5 standards are analysed by ICP-AES at zinc concentrations of 0, 0.5, 1, 2 and 5 mg/l. These standards were prepared in 100 ml volumetric flasks by dilution of a certified commercial solution at a zinc concentration of 1 g/l.

These volumetric flasks contain beforehand 8 ml of 37% concentrated hydrochloric acid, 3 ml of 65% concentrated nitric acid, 0.5 ml of 40% hydrofluoric acid and 2 g of boric acid. The standard solutions are analysed by ICP-AES at a wavelength of λ_{Zn}=202.613 nm. For each standard concentration (c), the intensity of the signal for zinc λ_{Zn} is plotted on a λ_{Zn}=f(c) graph, which corresponds to the calibration line (of y=ax+b type). The solution of the sample (diluted solution) of unknown concentration is subsequently measured under the same conditions as the standards. The measured intensity is related to the concentration by virtue of the calibration line obtained above. The concentration [c]ₐₛₕ as % by weight is thus obtained directly by the software because the test sample and the volume have been recorded beforehand. The zinc concentration in the pyrolysis black [c]_{black} as % by weight is obtained by the following equation:

$${[ c ]}_{black} = {[ c ]}_{ash} * 100 \times \% ash$$

The determination of the sulfur content in the pyrolysis blacks is carried out by a LECO furnace. LECO sulfur analysers are designed to measure in particular the sulfur content in organic and/or inorganic materials by combustion and non-dispersive infrared detection. Before carrying out the measurement of the sulfur content on the sample, the boats are cleaned and the furnace is calibrated. The boats for the LECO furnace are cleaned beforehand: it is a matter of analysing the empty boat, under the same conditions as the samples. The calibration curve is prepared starting from a commercial standard referred to as “BBOT”, the purity of which is greater than 99.99% and the carbon (C), hydrogen (H), nitrogen (N), oxygen (O) and sulfur (S) contents of which are guaranteed. These contents are as follows: C %: 72.52; H %: 6.09; N %: 6.51; 0%: 7.43 and S %: 7.44. Approximately exactly 10±3, 20±3 and 40±3 mg of BBOT are weighed out in a boat. The standard/boat assembly is introduced into the combustion furnace, regulated at 1350° C. under pure oxygen. The combination of the temperature of the furnace and the analysis flow rate causes the combustion of the sample and the release of sulfur and/or carbon in the form of SO₂(g). After a time of 20 s, oxygen starts to flow through the lance in order to accelerate the combustion of materials that are difficult to burn. Sulfur and/or carbon, in the form of SO₂(g), are entrained by a stream of oxygen as far as through the infrared detection cells. The software of the instrument plots a straight line relating the weight of standard introduced and the response observed (area) on the detector. A calibration line is thus obtained. After having thoroughly cleaned the sampling equipment, approximately exactly 80±5 mg of pyrolysis black are weighed out and introduced into a boat for the LECO furnace. The area of the SO₂ peak observed is related to the concentration by virtue of the calibration line. The software of the instrument subsequently calculates, by virtue of the weight of sample introduced into the boat, the % by weight of sulfur in the sample.

Preferably, the rubber composition according to the invention also comprises a carbon black which is not a pyrolysis carbon black for the purposes of the present invention, referred to as ASTM grade carbon black, as defined according to ASTM Standard D1765-96.

The rubber composition according to the invention may also comprise a reinforcing inorganic filler, preferably silica.

All carbon blacks, in particular blacks of the HAF, ISAF or SAF type, conventionally used in pneumatic tyres (“tyre-grade” blacks), are suitable as carbon blacks of ASTM grade. Among the latter, mention will more particularly be made of the reinforcing carbon blacks of the 100, 200 or 300 series (ASTM grades), such as, for example, the N115, N134, N234, N326, N330, N339, N347 or N375 blacks, or also, depending on the applications targeted, blacks of higher series (for example N660, N683 or N772). The carbon blacks might, for example, be already incorporated in an isoprene elastomer in the form of a masterbatch (see, for example, applications WO 97/36724 and WO 99/16600). The BET specific surface area of the carbon blacks is measured according to Standard D6556-10 [multipoint (a minimum of 5 points) method—gas: nitrogen—relative pressure p/po range: 0.1 to 0.3].

In the present patent application, the term “reinforcing inorganic filler” should be understood, by definition, as meaning any inorganic or mineral filler (regardless of its colour and its origin, natural or synthetic), also known as “white filler”, “clear filler” or even “non-black filler”, as opposed to carbon black, which is capable of reinforcing by itself alone, without any means other than an intermediate coupling agent, a rubber composition intended for the manufacture of pneumatic tyres, in other words capable of replacing, in its reinforcing role, a conventional tyre-grade carbon black; such a filler is generally characterized, in a known manner, by the presence of hydroxyl (—OH) groups at its surface.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica or silica of biobased origin exhibiting a BET specific surface area and also a CTAB specific surface area which are both less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface as described in application WO 03/16837.

The BET specific surface area of the silica is determined in a known way by gas adsorption using the Brunauer-Emmett-Teller method described in “The Journal of the American Chemical Society”, vol. 60, page 309, February 1938, more specifically according to the French Standard NF ISO 9277 of December 1996 (multipoint (5 point) volumetric method—gas: nitrogen—degassing: 1 hour at 160° C.—relative pressure p/po range: 0.05 to 0.17). The CTAB specific surface area of the silica is determined according to the French Standard NF T 45-007 of November 1987 (method B).

Mineral fillers of the aluminous type, in particular alumina (Al₂O₃) or aluminium (oxide) hydroxides, or else reinforcing titanium oxides, for example described in U.S. Pat. Nos. 6,610,261 and 6,747,087, are also suitable as reinforcing inorganic fillers.

The physical state in which the reinforcing inorganic filler is provided is not important, whether it is in the form of a powder, microbeads, granules, beads or any other suitable densified form. Of course, the term “reinforcing inorganic filler” is also understood to mean mixtures of different reinforcing inorganic fillers, in particular of highly dispersible siliceous and/or aluminous fillers.

A person skilled in the art will understand that use might be made, as filler equivalent to the reinforcing inorganic filler described in the present section, of a reinforcing filler of another nature, in particular organic nature, provided that this reinforcing filler is covered with an inorganic layer, such as silica, or else comprises, at its surface, functional sites, in particular hydroxyl sites, making it possible to establish the bond between the filler and the elastomer in the presence or absence of a covering or coupling agent.

In order to couple the reinforcing inorganic filler to the diene elastomer, use may be made, in a well-known manner, of an at least bifunctional coupling agent (or bonding agent) intended to provide a satisfactory connection, of chemical and/or physical nature, between the inorganic filler (surface of its particles) and the diene elastomer. Use is made in particular of organosilanes or polyorganosiloxanes which are at least bifunctional. The term “bifunctional” is understood to mean a compound having a first functional group capable of interacting with the inorganic filler and a second functional group capable of interacting with the diene elastomer. For example, such a bifunctional compound may comprise a first functional group comprising a silicon atom, said first functional group being capable of interacting with the hydroxyl groups of an inorganic filler, and a second functional group comprising a sulfur atom, said second functional group being capable of interacting with the diene elastomer.

Preferentially, the organosilanes are selected from the group consisting of (symmetrical or asymmetrical) organosilane polysulfides, such as bis(3-triethoxysilylpropyl) tetrasulfide, TESPT for short, sold under the name Si69 by Evonik, or bis(3-triethoxysilylpropyl)disulfide, TESPD for short, sold under the name Si75 by Evonik, polyorganosiloxanes, mercaptosilanes, blocked mercaptosilanes, such as S-(3-(triethoxysilyl)propyl) octanethioate, sold by Momentive under the name NXT Silane. More preferentially, the organosilane is an organosilane polysulfide.

The content of coupling agent is preferentially less than 12 phr, it being understood that it is generally desirable to use as little as possible of it. Typically, when a reinforcing inorganic filler is present, the content of coupling agent represents from 0.5% to 15% by weight relative to the amount of inorganic filler. Its content is preferentially within a range extending from 0.5 to 15 phr. This content is easily adjusted by a person skilled in the art depending on the content of inorganic filler used in the rubber composition.

The content of reinforcing filler, the reinforcing filler preferably predominantly, or even exclusively, comprising pyrolysis carbon black, is preferentially within a range extending from 20 to 200 phr, preferably from 30 to 150 phr, preferably from 40 to 100 phr, preferably from 50 to 80 phr.

### Crosslinking System

The crosslinking system can be any type of system known to a person skilled in the art in the field of rubber compositions for pneumatic tyres. It can in particular be based on sulfur and/or on peroxide and/or on bismaleimides.

Preferentially, the crosslinking system is based on sulfur; it is then referred to as a vulcanization system. The sulfur can be contributed in any form, in particular in the form of molecular sulfur or of a sulfur-donating agent. At least one vulcanization accelerator is also preferentially present, and, optionally, also preferentially, use may be made of various known vulcanization activators, such as zinc oxide, stearic acid or an equivalent compound, such as stearic acid salts, and salts of transition metals, guanidine derivatives (in particular diphenylguanidine), or else known vulcanization retarders.

Sulfur is used in a preferential content of between 0.5 and 12 phr, in particular between 1 and 10 phr. The vulcanization accelerator is used in a preferential content of between 0.5 and 10 phr, more preferentially between 0.5 and 8.0 phr.

Use may be made, as accelerator, of any compound capable of acting as accelerator of the vulcanization of diene elastomers in the presence of sulfur, in particular accelerators of the thiazole type, and also derivatives thereof, or accelerators of sulfenamide, thiuram, dithiocarbamate, dithiophosphate, thiourea and xanthate types. Mention may in particular be made, as examples of such accelerators, of the following compounds: 2-mercaptobenzothiazyl disulfide (abbreviated to MBTS), N-cyclohexyl-2-benzothiazolesulfenamide (CBS), N,N-dicyclohexyl-2-benzothiazolesulfenamide (DCBS), N-(tert-butyl)-2-benzothiazolesulfenamide (TBBS), N-(tert-butyl)-2-benzothiazolesulfenimide (TBSI), zinc dibenzyldithiocarbamate (ZBEC) and the mixtures of these compounds.

### Various Additives

The rubber compositions in accordance with the invention can also comprise all or part of the usual additives and processing aids known to a person skilled in the art and generally used in rubber compositions for pneumatic tyres, such as, for example, plasticizers (such as plasticizing oils and/or plasticizing resins), pigments, protective agents, such as antiozone waxes, chemical antiozonants or antioxidants, or anti-fatigue agents.

Preferably, the rubber composition according to the invention does not comprise nitrile compounds or comprises less than 10 phr, preferably less than 5 phr, in a preferred way less than 2 phr, very preferably less than 1 phr and more preferentially still less than 0.5 phr thereof.

The rubber composition can be either in the uncured state (before crosslinking or vulcanization) or in the cured state (after crosslinking or vulcanization).

### Finished or Semi-Finished Rubber Article and Pneumatic Tyre

Another subject of the present invention is a finished or semi-finished rubber article comprising a rubber composition according to the invention. Particularly preferred rubber articles are for example conveyor belts, belts, inflatable articles.

Another subject of the present invention is a pneumatic or non-pneumatic tyre which comprises a rubber composition according to the invention. A non-pneumatic tyre means a tyre capable of supporting the load of a vehicle by a means other than a pressurized gas, for example by means of stays.

It is possible to define, within the tyre, three types of regions:
The radially exterior region in contact with the ambient air, comprising the layers referred to as “external layers”, these layers essentially comprising the tread and the outer sidewall of the pneumatic tyre. An outer sidewall is an elastomeric layer positioned outside the carcass reinforcement relative to the internal cavity of the tyre, between the crown and the bead, so as to completely or partially cover the region of the carcass reinforcement extending from the crown to the bead.
The radially interior region in contact with the inflation gas, or another means of standing up to the load, this region generally consisting, in the case of pneumatic tyres, of the layer airtight to the inflation gases, sometimes known as interior airtight layer or inner liner.
The internal region of the tyre, that is to say that between the exterior and interior regions. This region includes layers or plies which are referred to here as internal layers of the tyre. These are, for example, carcass plies, tread underlayers, tyre belt plies or any other layer which is not in contact with the ambient air or the inflation gas of the tyre or any other means of standing up to the load.

The rubber composition defined in the present description is particularly well suited to the inner and outer layers of tyres, and in particular, for the outer layers, to the tread compositions and, for the inner layers, to the layers of the “bottom” region, at the level of the bead of the tyre, such as, for example, bead fillers, crown feet and combinations of these inner layers.

The rubber composition according to the invention may also be suitable for the internal and external layers of non-pneumatic tyres, in particular for the treads of non-pneumatic tyres and the bottom regions of these non-pneumatic tyres.

The invention relates in particular to tyres intended to equip motor vehicles of passenger vehicle type, SUVs (Sport Utility Vehicles), or two-wheel vehicles (in particular motorcycles), or aircraft, or also industrial vehicles selected from vans, heavy-duty vehicles, that is to say underground trains, buses, heavy road transport vehicles (lorries, tractors, trailers) or off-road vehicles, such as heavy agricultural vehicles or earthmoving equipment, and others.

The invention relates to the articles comprising a rubber composition according to the invention, both in the uncured state (that is to say, before curing) and in the cured state (that is to say, after crosslinking or vulcanization).

### Preparation of the Rubber Compositions

The rubber composition in accordance with the invention can be manufactured in appropriate mixers using two successive preparation phases well known to a person skilled in the art:
a first phase of thermomechanical working or kneading (“non-productive” phase), which can be carried out in a single thermomechanical step during which all the necessary constituents, in particular the elastomeric matrix, the fillers and the optional other various additives, with the exception of the crosslinking system, are introduced into an appropriate mixer, such as a standard internal mixer (for example of ‘Banbury’ type). The incorporation of the filler in the elastomer can be carried out in one or more goes by thermomechanically kneading. If the filler is already incorporated, totally or partially, in the elastomer in the form of a masterbatch, as is described, for example, in the applications WO 97/36724 or WO 99/16600, it is the masterbatch which is directly kneaded and, where appropriate, the other elastomers or fillers present in the composition which are not in masterbatch form, and also the various other optional additives, with the exception of the crosslinking system, are incorporated.

The non-productive phase is carried out at high temperature, up to a maximum temperature of between 110° C. and 190° C., preferably between 130° C. and 180° C., for a period of time generally of between 2 and 10 minutes.
a second phase of mechanical working (“productive” phase), which is carried out in an external mixer, such as an open mill, after cooling the mixture obtained during the first non-productive phase down to a lower temperature, typically of less than 110° C., for example between 40° C. and 100° C. The crosslinking system is then incorporated and the combined mixture is then mixed for a few minutes, for example between 2 and 15 min.

The process for preparing such rubber compositions comprises, for example, the following steps:
a) incorporating a reinforcing filler in a diene elastomer during a first step (termed “non-productive” step), everything being kneaded thermomechanically (for example, in one or more goes), until a maximum temperature of between 110° C. and 190° C. is reached;
b) cooling the combined mixture to a temperature of less than 100° C.;
c) subsequently incorporating, during a (“productive”) second step, a crosslinking system;
d) kneading everything up to a maximum temperature of less than 110° C.

Between 1 and 30 phr of the epoxy resin and between 0.5 and 15 phr of a hardener can be introduced, independently of one another, either during the non-productive phase (a) or during the productive phase (c). Preferably, the epoxy resin is introduced during the non-productive phase (a), whereas the hardener is introduced during the productive phase (c).

The final rubber composition thus obtained can subsequently be calendered, for example in the form of a sheet or plaque, in particular for laboratory characterization, or also extruded in the form of a rubber semi-finished product (or profiled element) used in the manufacture of a pneumatic tyre.

The rubber composition may be crosslinked in a manner known to a person skilled in the art, for example at a temperature of between 130° C. and 200° C., under pressure.

### EXAMPLES

### Measurement Methods

### Mooney Plasticity

Use is made of an oscillating consistometer as described in French Standard NF T 43-005 (1991). The Mooney plasticity measurement is carried out according to the following principle: the rubber composition in the uncured state (i.e., before curing) is moulded in a cylindrical chamber heated to 100° C. After preheating for one minute, the rotor rotates within the test specimen at 2 revolutions/minute and the working torque for maintaining this movement is measured after rotating for 4 minutes. The Mooney plasticity (ML 1+4) is expressed in “Mooney units” (MU, with 1 MU=0.83 newton·metre).

It should be remembered that, in a way well known to a person skilled in the art, the lower the Mooney plasticity, the easier the material is to work. Of course, beyond a certain value (for example, 20 MU), the material becomes too liquid to be usable, in particular for manufacturing internal layers.

### Tensile Tests

The tests were carried out in accordance with French Standard NF T 46-002 of September 1988. All the tensile measurements were carried out at a temperature representative of the operating temperature of the rubber composition in a tyre (100±2° C.) and under standard hygrometry conditions (50±5% relative humidity), according to French Standard NF T 40-101 (December 1979).

At second elongation (that is to say, after accommodation), the nominal secant modulus, calculated by reducing to the initial cross section of the test specimen, (or apparent stress, in MPa) was measured at 10% and 50% elongation, denoted respectively MA10 and MA50, on samples cured at 150° C. for 60 minutes.

### Preparation of the Compositions

The tests which follow are carried out in the following way: the diene elastomer, the reinforcing filler, between 1 and 30 phr of the epoxy resin, and also the various other ingredients, with the exception of the crosslinking system, are successively introduced into an internal mixer (final degree of filling: approximately 70% by volume), the initial vessel temperature of which is approximately 60° C. Thermomechanical working (non-productive phase) is then carried out in one step, which lasts in total approximately from 3 to 4 min, until a maximum “dropping” temperature of 165° C. is reached.

The mixture thus obtained is recovered and cooled and then sulfur, an accelerator of sulfenamide type and the hardener are incorporated on a mixer (homofinisher) at 30° C., everything being mixed (productive phase) for an appropriate time (for example between 5 and 12 min).

The rubber compositions thus obtained are subsequently calendered, either in the form of plaques (thickness of 2 to 3 mm) or of thin sheets of rubber, for the measurement of their physical or mechanical properties, or extruded in the form of a profiled element.

The crosslinking of the rubber composition is carried out at a temperature of 150° C., for 60 min, under pressure.

TABLE 1

| Constituent | C.1 | C.2 | C.3 | C.4 |
|---|---|---|---|---|
| NR (1) | 100 | 100 | 100 | 100 |
| Carbon black (2) | 70 | 70 | | |
| Pyrolysis black (3) | | | 87 | 87 |
| Phenol/formaldehyde resin (4) | 12 | | | 12 |
| Epoxy resin (5) | | 12 | 16 | |
| HMT (6) | 3 | | | 3 |
| Urea (7) | | 2.5 | 3.4 | |
| ZnO (8) | 3 | 3 | 3 | 3 |
| Stearic acid (9) | 2 | 2 | 2 | 2 |
| GPPD (10) | 3 | 3 | 3 | 3 |
| Sulfur | 3 | 3 | 3 | 3 |
| CBS (11) | 2 | 2 | 2 | 2 |
| Mooney Index (base 100) | 100 | 86 | 97 | 114 |
| MA50 (base 100) | 100 | 96 | 99 | 99 |
| tan(δ)max | 0.28 | 0.42 | 0.31 | 0.23 |

(1) Natural rubber;
(2) Carbon black of ASTM N326 grade (name according to ASTM Standard D-1765);
(3) “P550” from Scandinavian Enviro Systems, pyrolysis carbon black with a sulfur content of between 2% and 3% by weight relative to the total weight of the pyrolysis black measured according to the method of the description, and the ash content is at most 20% by weight relative to the total weight of the pyrolysis black, measured according to the method of the description;
(4) Phenol-formaldehyde novolac resin (Peracit 4536K from Perstorp);
(5) Epoxy resin (EPN 1138 from Huntsman);
(6) Hexamethylenetetramine (from Degussa);
(7) Urea from Univar Solution;
(8) Zinc oxide (industrial grade - Umicore);
(9) Stearin (Pristerene 4931 from Uniqema);
(10) N-(1,3-Dimethylbutyl)-N′-phenyl-para-phenylenediamine (Santoflex 6-PPD from Flexsys);
(11) N-cyclohexylbenzothiazolesulfenamide (Santocure CBS from Flexsys).

The replacement of the ASTM carbon black (composition C. 1) with a pyrolysis carbon black (composition C.4), while adjusting the contents so that the medium-strain stiffness (MA50) is maintained, makes it portable to improve the hysteresis loss properties. Conversely, the viscosity in the uncured state is substantially increased, which makes the shaping, and therefore the processability, of this C.4 rubber composition more difficult.

The replacement of a phenol/formaldehyde resin (composition C.1) with an epoxy resin (composition C.2) with medium-strain stiffness maintained makes it possible to obtain a lower viscosity in the uncured state. Conversely, the hysteresis loss properties once the rubber composition C.2 has been crosslinked are substantially increased.

The combination according to the invention of an epoxy resin and a pyrolysis carbon black (composition C.3) makes it possible to obtain a rubber composition which exhibits both good processability and advantageous performances once crosslinked, with a medium-strain stiffness maintained and hysteresis losses similar to those of the control rubber composition C.1.

TABLE 2

| Constituent | C.5 | C.3 | C.6 | C.4 | C.7 | C.8 |
|---|---|---|---|---|---|---|
| NR (1) | 100 | 100 | 100 | 100 | 100 | 100 |
| Pyrolysis black (3) | 87 | 87 | 87 | 87 | 87 | 87 |
| Phenol/formaldehyde resin (4) | | | | 12 | 16 | 20 |
| Epoxy resin (5) | 12 | 16 | 20 | | | |
| HMT (6) | | | | 3 | 3 | 4 |
| Urea (7) | 3 | 3 | 4 | | | |
| ZnO (8) | 3 | 3 | 3 | 3 | 3 | 3 |
| Stearic acid (9) | 2 | 2 | 2 | 2 | 2 | 2 |
| 6PPD (10) | 3 | 3 | 3 | 3 | 3 | 3 |
| Sulfur | 3 | 3 | 3 | 3 | 3 | 3 |
| CBS (11) | 2 | 2 | 2 | 2 | 2 | 2 |
| Resin (base 100) | 100 | 136 | 163 | 100 | 136 | 163 |
| MA10 (base 100) | 100 | 122 | 133 | 100 | 112 | 116 |

The references of the constituents are identical to those of Table 1.

It is observed in these examples that the combination of a pyrolysis black and an epoxy resin exhibits a better evolution of stiffness than the combination of a pyrolysis black and a phenol/formaldehyde resin.

1.-15. (canceled)

16. A rubber composition based on at least:
a diene elastomer;
a reinforcing filler comprising pyrolysis carbon black;
a crosslinking system;
between 1 and 30 phr of an epoxy resin; and
between 0.5 and 15 phr of a hardener.

17. The rubber composition according to claim 16, wherein the reinforcing filler also comprises a carbon black other than the pyrolysis carbon black.

18. The rubber composition according to claim 16, wherein the reinforcing filler also comprises a reinforcing inorganic filler.

19. The rubber composition according to claim 16, wherein the reinforcing filler predominantly comprises the pyrolysis carbon black.

20. The rubber composition according to claim 16, wherein the reinforcing filler consists of the pyrolysis carbon black.

21. The rubber composition according to claim 16, wherein the pyrolysis carbon black has an ash content within a range extending from 5% to 30% by weight based relative to a total weight of the pyrolysis carbon black.

22. The rubber composition according to claim 16, wherein the pyrolysis carbon black has a sulfur content of greater than 2% by weight relative to a total weight of the pyrolysis carbon black.

23. The rubber composition according to claim 16, wherein the diene elastomer is selected from highly unsaturated diene elastomers.

24. The rubber composition according to claim 16, wherein the diene elastomer is selected from the group consisting of natural rubber, synthetic polyisoprenes, polybutadienes, butadiene copolymers, isoprene copolymers and mixtures thereof.

25. The rubber composition according to claim 16, wherein the epoxy resin is selected from the group consisting of resins of the type 2,2-bis[4-(glycidyloxy)phenyl]propane, poly[(o-cresyl glycidyl ether)-co-formaldehyde], poly[(phenyl glycidyl ether)-co-formaldehyde], poly[(phenyl glycidyl ether)-co-(hydroxybenzaldehyde glycidyl ether)], tri(glycidoxyphenyl)methane, tetra(glycidoxyphenyl)ethane, and mixtures thereof.

26. The rubber composition according to claim 25, wherein the epoxy resin is selected from the group consisting of resins of the type poly[(o-cresyl glycidyl ether)-co-formaldehyde], poly[(o-phenyl glycidyl ether)-co-formaldehyde], tri(glycidoxyphenyl)methane, tetra(glycidoxyphenyl)ethane, and mixtures thereof.

27. The rubber composition according to claim 16, wherein the epoxy resin content in the composition is between 10 and 28 phr.

28. The rubber composition according to claim 16, wherein the hardener is a hardener selected from the group consisting of aromatic diamines, aliphatic diamines, anhydrides, and ureas.

29. The rubber composition according to claim 28, wherein the hardener is a urea hardener selected from the group consisting of carbamide, N,N′-dimethylurea, ethyleneurea, N-phenylurea, 1,3-diphenylurea and 1,1′-(4-methyl-m-phenylene) bis(3,3-dimethylurea) compounds.

30. A finished or semi-finished rubber article comprising the rubber composition according to claim 16.

31. The finished or semi-finished rubber article according to claim 30, wherein the finished or semi-finished rubber article is selected from the group consisting of conveyor belts, belts, and inflatable articles.

32. A pneumatic or non-pneumatic tire comprising the rubber composition according to claim 16.
